(19) United States
(12) Patent Application Publication
(10) Pub. No.: US 2010/0176020 A1
(43) Pub. Date: Jul. 15, 2010

(54) PACKAGING WITH PERFORATED OPENING STRIP

(75) Inventor: Joseph M. Scarpy, Lake in the Hills, IL (US)

Correspondence Address: HARNESS, DICKEY, & PIERCE, P.L.C, 7700 Bonhomme, Suite 400, ST. LOUIS, MO, 63105, US

(73) Assignee: Tek Packaging LLC, Huntley, IL (US)

(21) Appl. No.: 12/685,782

(22) Filed: Jan. 12, 2010

Related U.S. Application Data
(60) Provisional application No. 61/144,376, filed on Jan. 13, 2009.

(51) Int. Cl. B65D 77/30; B31B 1/00; B31B 1/90

(52) U.S. Cl. 206/469; 493/59; 206/470; 493/102

(57) ABSTRACT

Disclosed herein are various exemplary embodiments of packaging having perforated opening strips that may provide for relatively easy, convenient, and/or tamper-evident opening of the packaging. In an exemplary embodiment, a packaging unit generally includes a rearward wall, a forward wall, and a hinge connecting the forward wall to the rearward wall. A sealable interface is generally opposite the hinge. The rearward and forward walls cooperatively define an item-receiving compartment generally between the hinge and sealable interface. First and second sets of spaced-apart perforations penetrate at least partially through the rearward wall, such that a perforated opening strip is integrally defined in the rearward wall by the first and second sets of spaced-apart perforations generally between the sealable interface and the item-receiving compartment. The perforated opening strip may be removable even while the rearward and forward walls may remain sealed to each other at or along the sealable interface.

### CROSS-REFERENCE TO RELATED APPLICATION

This application claims the benefit of U.S. Provisional Application No. 61/144,376 filed Jan. 13, 2009. The entire disclosure of the above application is incorporated herein by reference.

### FIELD

The present disclosure relates to packaging having a perforated opening strip that allows for relative easy or convenient opening of the packaging that is tamper evident.

### BACKGROUND

This section provides background information related to the present disclosure which is not necessarily prior art.

Retail stores commonly sell a great variety of products and merchandise in sealed packaging, including cellular phones, razors, disposable cameras, toys, among other items, etc. After purchasing a product in sealed packaging, the customer must oftentimes have to cut the packaging with a knife or scissors to open the packaging. It can prove to be a rather challenging task to cut open the sealed packaging without damaging the packaged product. The task of cutting open the sealed packaging may also prove dangerous especially for young children.

### SUMMARY

This section provides a general summary of the disclosure, and is not a comprehensive disclosure of its full scope or all of its features.

Disclosed herein are various exemplary embodiments of packaging having perforated opening strips that may provide for relatively easy, convenient, and/or tamper-evident opening of the packaging. In an exemplary embodiment, a packaging unit generally includes first and second walls. The first wall includes first and second portions and first and second sets of spaced-apart perforations. The second wall includes a first portion sealable to the first portion of the first wall. The second wall also includes a second portion configured to cooperate with the second portion of the first wall to define an item-receiving compartment therebetween when the packaging unit is closed. The first and second sets of spaced-apart perforations penetrate at least partially through the first wall, such that a perforated opening strip is integrally defined in the first wall by the first and second sets of spaced-apart perforations generally between the first and second portions of the first wall. The perforated opening strip may be removable even while the first portions of the first and second walls may remain sealed to each other. The removal of the perforated opening strip may detach the first and second portions of the first wall from each other, which, in turn, may allow the second portion of the first wall to be movable relative to the second wall from a closed position towards an open position for opening the packaging unit.

In another exemplary embodiment, a packaging unit generally includes a rearward wall and a forward wall. There may be a hinge connecting the forward wall to the rearward wall. A sealable interface associated with the rearward and forward walls is generally opposite the hinge. The rearward and forward walls cooperatively define an item-receiving compartment generally between the hinge and sealable interface. First and second sets of spaced-apart perforations penetrate at least partially through the rearward wall, such that a perforated opening strip is integrally defined in the rearward wall by the first and second sets of spaced-apart perforations generally between the sealable interface and the item-receiving compartment. The perforated opening strip may be removable even while the rearward and forward walls may remain sealed to each other at or along the sealable interface. The removal of the perforated opening strip may detach a first portion of the rearward wall associated with the sealable interface from a second portion of the rearward wall connected to the hinge. This detachment, in turn, may allow the forward wall (and the first portion of the rearward wall when sealed thereto) to be hingedly moved relative to the second portion of the rearward wall about the hinge from a closed position towards an open position for opening the packaging unit.

Other aspects of the present disclosure relate to methods of making packaging, methods of packaging items, and methods of opening packaging. For example, disclosed herein is an exemplary method of making a packaging unit, where the method generally includes forming first and second walls of the packaging unit that are connected by a hinge and forming first and second sets of perforations in the first wall. The perforations penetrate at least partially through the first wall without penetrating a second wall of the packaging unit, such that a removable perforated opening strip is integrally defined in the first wall by the first and second sets of spaced-apart perforations generally between first and second portions of the first wall. Removal of the perforated opening strip only removes the portion of the first wall between the first and second sets of perforations without removing any portion of the second wall.

There are also disclosed herein examples of methods of packaging an item within a packaging unit having first and second walls cooperatively defining an item-receiving compartment and a perforated opening strip integrally defined in the first wall by first and second sets of spaced-apart perforations in the first wall. In one such example, a method generally includes sealing portions of the first and second walls of the packaging unit to each other with an item within the item-receiving compartment, such that the perforated opening strip is generally between the item-receiving compartment and the sealed portions of the first and second walls.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a rearward perspective of exemplary packaging unit with a perforated opening strip and pull tab in the rearward wall of the packaging unit according to an exemplary embodiment;

FIG. 2 is a forward perspective view of the packaging unit shown in FIG. 1, and illustrating an outwardly protruding portion that defines a portion of the packaging unit's item-receiving compartment;

FIG. 3 is a rearward view of the packaging unit shown in FIG. 1, and illustrating the perforations along the packaging unit's rearward wall that define the perforated opening strip and pull tab;

FIG. 4 is a forward plan view of packaging unit shown in FIG. 1;

FIG. 5 is a side plan view of the packaging unit shown in FIG. 1;

FIG. 6 is a rearward perspective view of the packaging unit shown in FIG. 1, and illustrating the perforated opening strip after it has been partially removed or torn away from the packaging unit's rearward wall;

FIG. 7 is a perspective view of the packaging unit shown in FIG. 1, and illustrating the perforated opening strip fully removed or detached from the rearward wall and also illustrating the packaging unit opened;

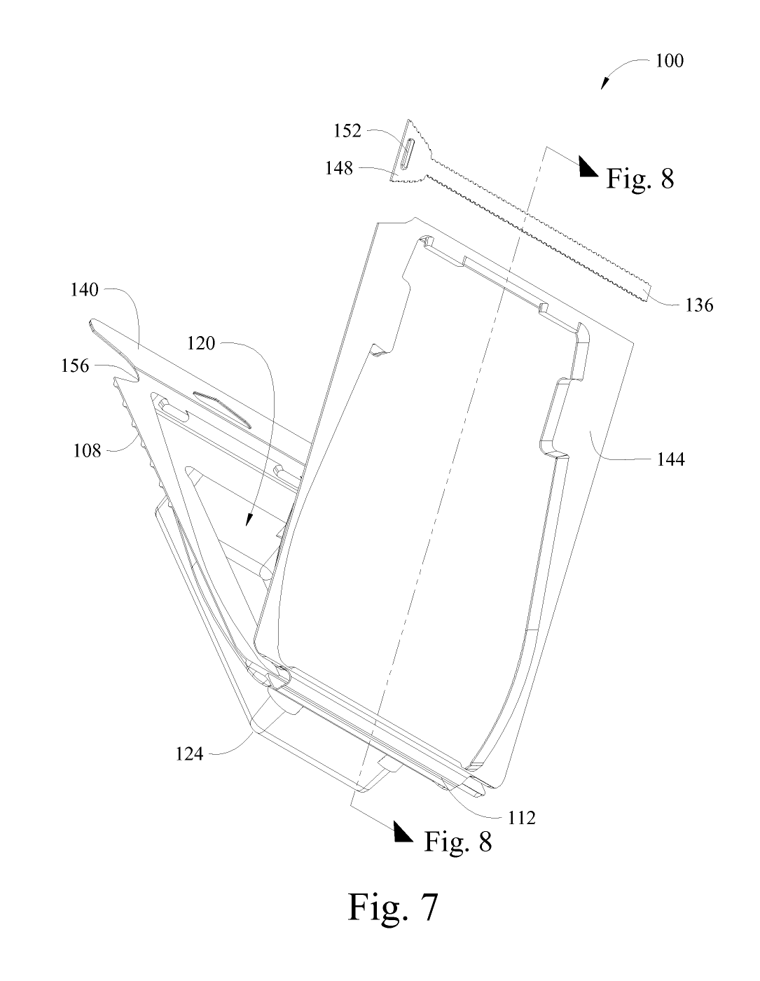

FIG. 8 is a cross-sectional side view of the packaging unit shown in FIG. 7 taken along the line 8-8 in FIG. 7;

FIG. 9 is a plan view of the packaging unit shown in FIG. 1 laying in an open flat configuration before sealing the packaging unit; and

FIG. 10 is a side plan view of the open and unsealed packaging unit shown in FIG. 9.

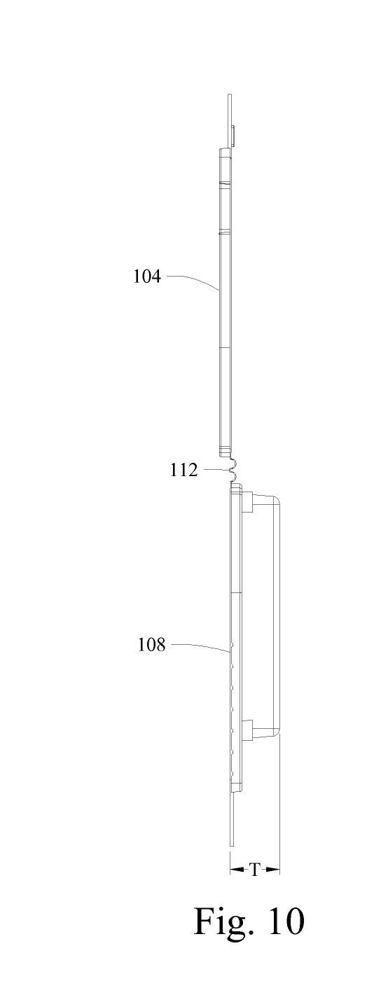

Corresponding reference numerals indicate corresponding parts throughout the several views of the drawings.

### DETAILED DESCRIPTION

Example embodiments will now be described more fully with reference to the accompanying drawings.

Disclosed herein are various exemplary embodiments of packaging having perforated opening strips. Such packaging may be used in conjunction with an item, product, merchandise, article, object, etc. (hereinafter generally referred to as “item”). For example, an item may be packaged within a packaging unit having a perforated opening strip, where the packaging unit may be sealed (e.g., heat sealed, etc.). Rather than having to cut open the sealed packaging as is the case with many existing packaging solutions, a user may pull the perforated opening strip (sort of like pulling a zipper) to remove or detach the perforated opening strip from the packaging unit. With the perforated opening strip removed, the user may then open the packaging unit thus avoiding any cutting of the packaging unit with a knife, scissors, etc. In addition to providing a convenient means for opening the packaging unit, the perforated opening strip also provides a visual indicator or means for determining whether anyone has tampered with, e.g., opened or tried to open, the sealed packaging unit before the rightful owner (e.g., purchaser, etc.). Accordingly, exemplary embodiments disclosed herein include packaging having perforated opening strips that allow for relatively convenient or easy opening of the packaging (after being sealed) that is tamper evident.

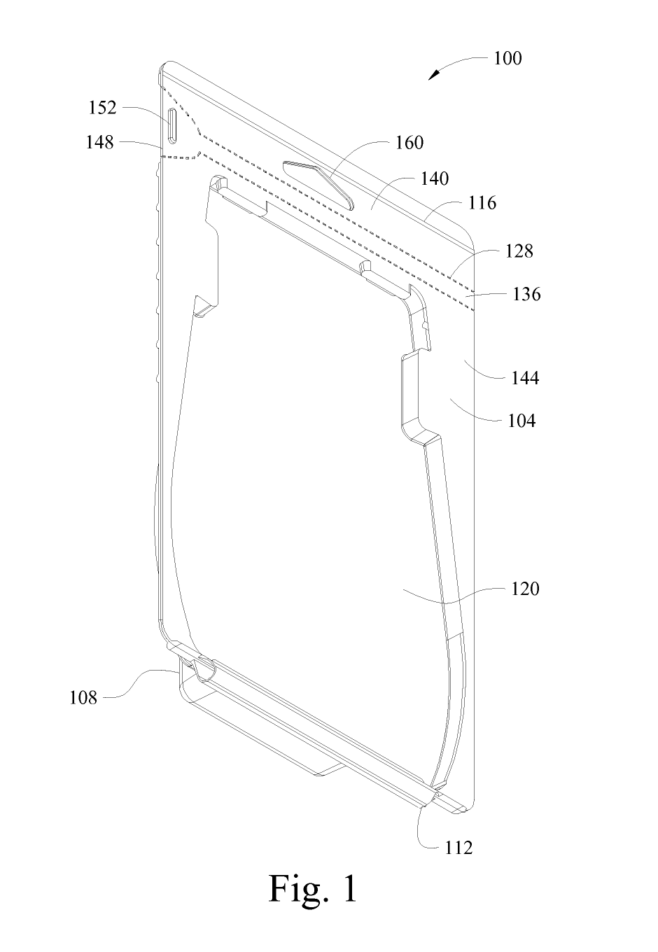

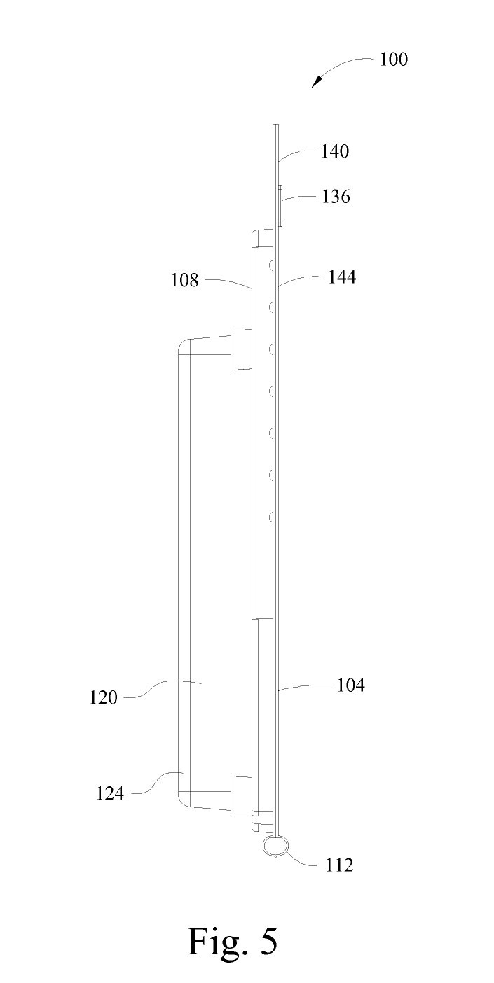

FIGS. 1 through 5 illustrates an exemplary packing unit 100 embodying one or more aspects of the present disclosure. As shown in FIG. 1, the packaging unit 100 includes walls or panels 104, 108 and a hinge 112 connecting the walls 104, 108. For ease of identification, the walls 104, 108 are also referred to herein, respectively, as first or rearward wall 104 and second or forward wall 108. Alternative embodiments may include other means, besides hinge 112, for joining the walls or panels 104, 108 to one another.

A sealable interface 116 is associated with the rearward and forward walls 104, 108 generally opposite the hinge 112. In this example, the sealable interface 116 includes and is defined at least partially by portions of the forward and rearward walls 104, 108, which, in turn, are configured (e.g., sized, shaped, etc.) to allow a seal, joint, seam, bond, etc. to be formed between the walls 104, 108 at or along the sealable interface 116. The walls 104, 108 may be sealed, joined, bonded, connected, coupled, etc. to each other at or along the sealable interface 116, for example, by heat sealing, adhesive bonding, ultrasonic bonding, radio frequency bonding, mechanical interlock, etc. The sides or lateral edge portions of the packaging unit 100 may also be sealed in some embodiments, or they may remain unsealed in other embodiments.

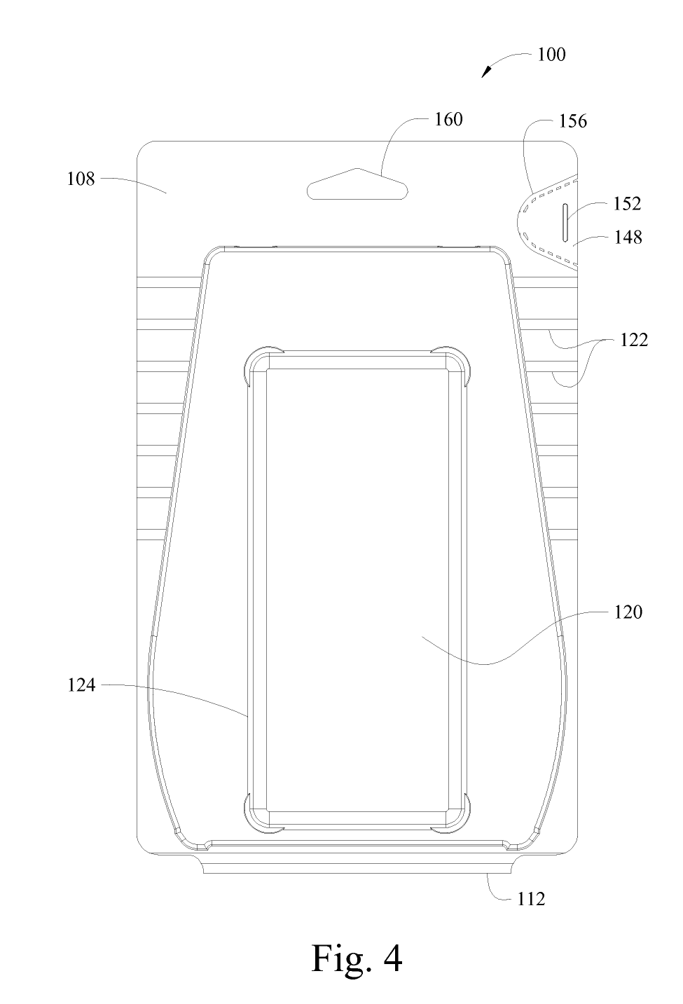

The walls 104, 108 cooperatively define an item-receiving compartment, cavity, or chamber 120 generally between the hinge 112 and sealable interface 116. The item-receiving compartment 120 may be configured (e.g., sized, shaped, etc.) to receive any of a wide range of items. In some embodiments, the item-receiving compartment 120 may be configured (e.g., shaped, sized, etc.) so as to correspond with the profile shape, size, etc. of the item to be received in the item-receiving compartment 120. For example, the item-receiving compartment 120 may be configured so as to frictionally receive (e.g., form a friction or interference fit with, etc.) the item, for example, to inhibit the item from shifting or moving around within the item-receiving compartment 120 when the packaging unit 100 is being carried or transported with the item packaged therein. In various embodiments, the walls 104, 108 may also have one or more features (e.g., corresponding internal wall portions, mechanical interlocking features, detents, dimples, etc.) for engaging (e.g., frictionally engaging, etc.) the walls 104, 108 to each other when the packaging unit 100 is closed. This engagement may help keep the packaging unit 100 closed, such as before the walls 104, 108 have been sealed to each other at or along the interface 116. In addition, the forward wall 108 may include ribs or other features (e.g., horizontally extending ribs 122 in FIG. 4, etc.) for reinforcing or strengthening the packaging unit 100.

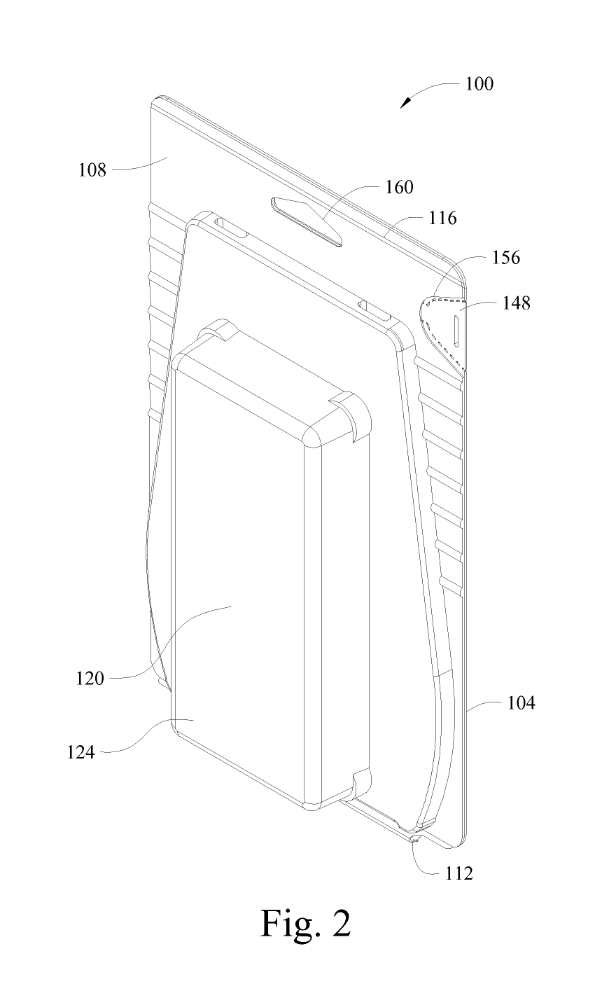

As shown in FIG. 2, a forward portion of the item-receiving compartment 120 is defined by a generally rectangular outwardly protruding portion 124 of the forward wall 108. For this exemplary embodiment, the generally rectangular outwardly protruding portion 124 is configured for frictionally receiving therein a cellular phone having an external housing with a shape and size corresponding to the item-receiving compartment 120. Alternative embodiments may include packaging with item-receiving compartments configured for receiving other items, such as other electronic devices, razors, disposable cameras, toys, clothing, edibles, books, among virtually any other item, etc. Accordingly, embodiments of the present disclosure should not be limited to use with any one particular type of item.

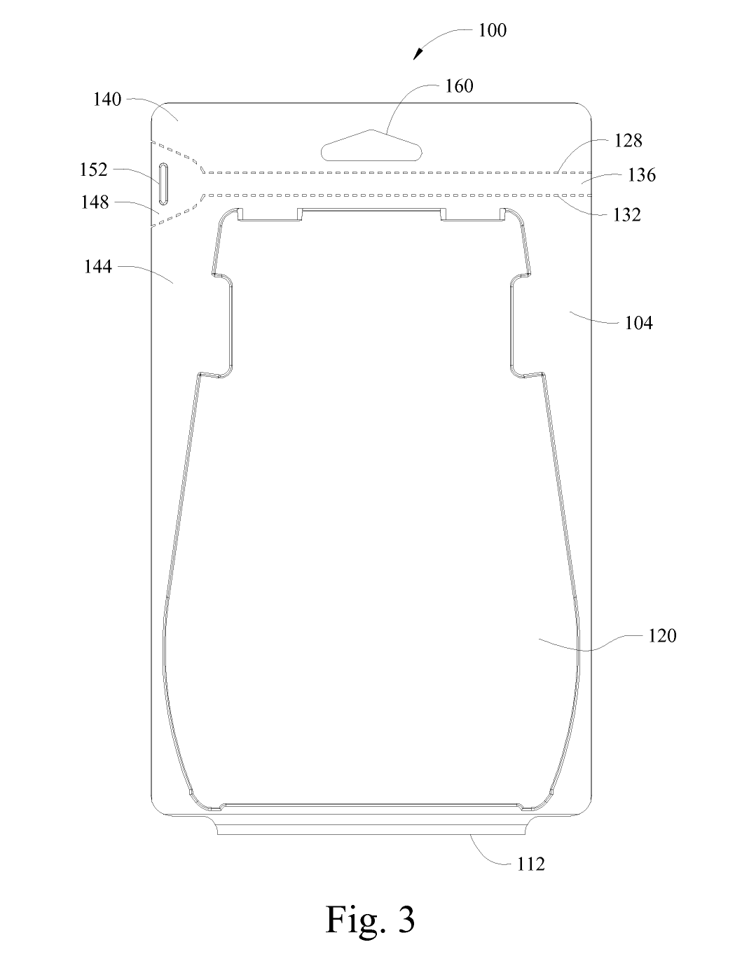

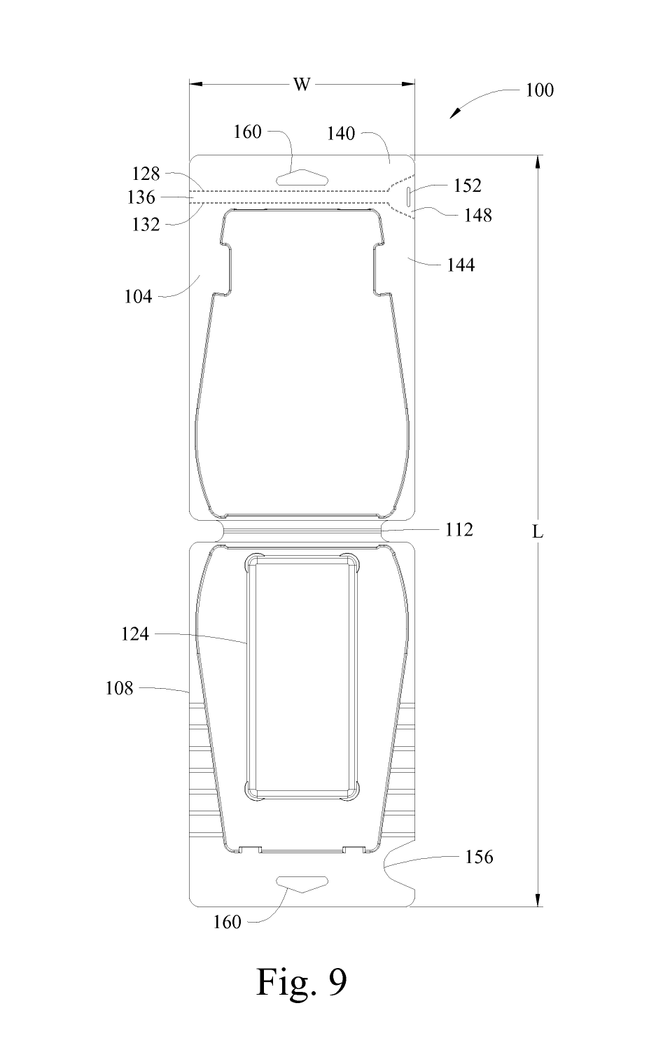

With continued reference to FIGS. 1 through 5, the packaging unit 100 also includes first and second sets of spaced-apart perforations 128, 132. As shown in FIG. 9 and by a comparison of FIGS. 3 and 4, this embodiment only has the perforations 128, 132 formed in the rearward wall 104, such that the forward wall 108 does not include any of the perforations 128, 132. Depending on the particular embodiment, the perforations 128, 132 may penetrate partially or entirely through the thickness of the rearward wall 104. Alternative embodiments include packaging units having perforations in the forward wall but not in the rearward wall.

In an exemplary embodiment, the perforations 128, 132 may be die cut into the rearward wall 104 using a rotary cutter blade having a blade length of about 3/16 inches and blades spaced apart about 1/32 inches. In this example, the perforations 128, 132 are generally rectangular with a length of about of about 3/16 inches and with un-cut portions or lands having a length of 1/32 inches between the perforations 128, 132. Alternative embodiments may include perforations having different configurations (e.g., different shapes, sizes, spacing, etc.) and/or may be formed by different processes other than die cutting.

As shown in FIGS. 1, 3, and 6, a perforated opening strip 136 is integrally defined in the rearward wall 104 by the perforations 128, 132 generally between the sealable interface 116 and the item-receiving compartment 120. The perforations 128, 132 extend completely across a width between the lateral side edges of the rearward wall 104. Having the perforations 128, 132 extend completely to the free edges of the rearward wall 104 may make it easier for a user to begin tearing away the perforated opening strip 136. Alternative embodiments may include perforations that do not extend all the way to the free edges, for example, to inhibit the perforated opening strip 136 from inadvertently beginning to separate from the packaging unit 100, such as when a user is examining the packaging unit 100 before purchasing or during shipping of the packaging unit 100.

The perforations 128, 132 may operate to concentrate the applied stress of tearing created, for example, by a user pulling to remove the perforated opening strip 136. By concentrating the applied stress, the perforated opening strip 136 is more easily torn as compared to the uncut or un-perforated portions 140, 144 of the rearward wall 104.

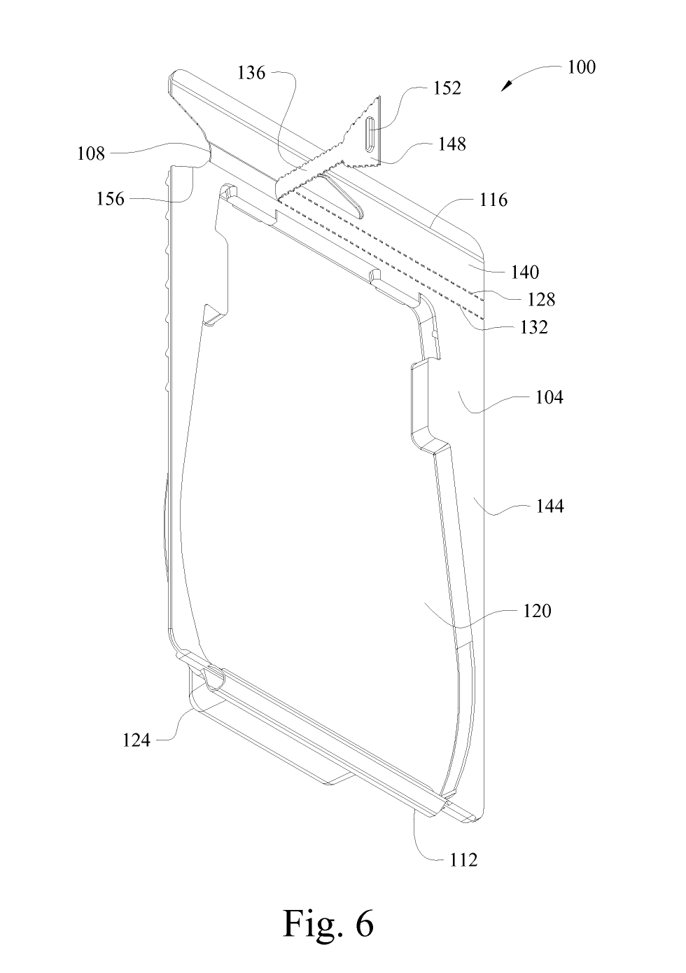

The forward and rearward walls 104, 108 are unsealed in a region generally between the perforated opening strip 136 and the item-receiving compartment 120. As shown by FIGS. 6 and 9, the perforated opening strip 136 may be removable from the packaging unit 100 by application of a manual force (e.g., by a user pulling the perforated opening strip 136 like a zipper, etc.) even while the rearward and forward walls 104, 108 remain sealed to each other at or along the sealable interface 116.

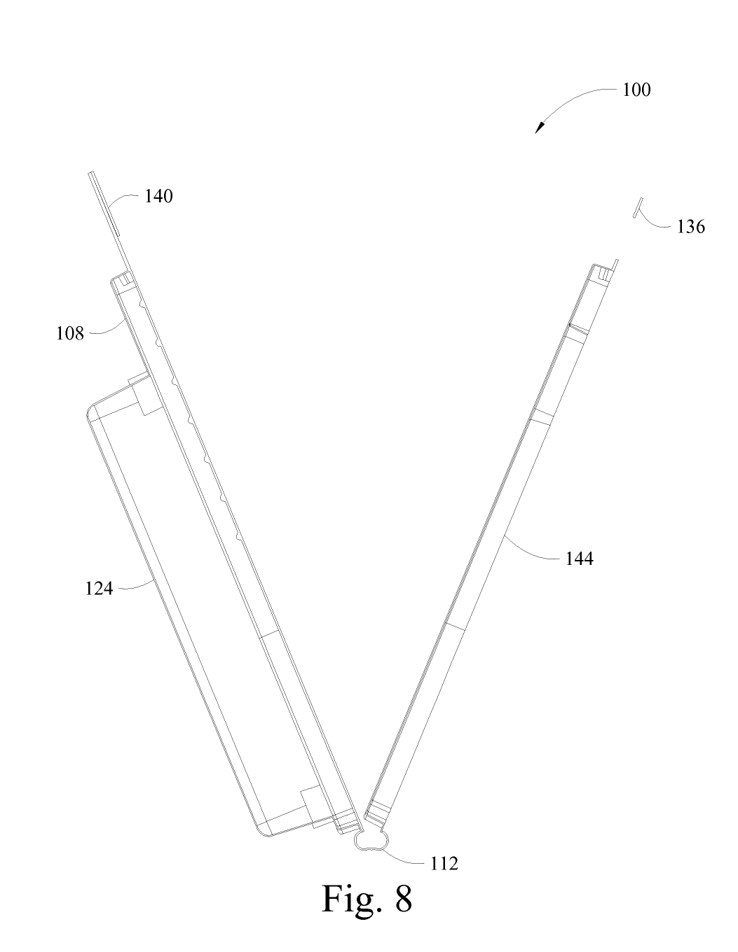

With continued reference to FIG. 9, the removal of the perforated opening strip 136 from the packaging unit 100 may detach the first or upper portion 140 of the rearward wall 104 from the second or lower portion 144 of the rearward wall 104. The detachment allows the forward wall 108 (and the rearward wall's first portion 140 sealed or connected thereto along or at the sealable interface 116) to be hingedly moved about the hinge 112 relative to the rearward wall's second portion 144. For example, FIGS. 8 and 9 illustrate the packaging unit 100 after the forward wall 108 (and the rearward wall's first portion 140 sealed or connected thereto along or at the sealable interface 116) has been moved about the hinge 112 relative to the rearward wall's second portion 144 from a closed position towards an open position. In this example, a user may choose to move the forward wall 108 (and the rearward wall's first portion 140 sealed or connected thereto along or at the sealable interface 116) about the hinge 112 relatively away from the rearward wall's second portion 144 while holding the rearward wall's second portion 144 stationary. But the user may also choose to move the rearward wall's second portion 144 relatively away from the forward wall 108 (and the rearward wall's first portion 140) while holding the forward wall 108 stationary. Or the user may move both the rearward wall's second portion 144 and the forward wall 108 (and the rearward wall's first portion 140 coupled thereto) relative to each other to open the packaging unit 100. Accordingly, the particular manner and variations by which a user chooses to open and close the packaging unit 100 should not be viewed as limitations to the scope of the present disclosure.

In the illustrated embodiment, the sealable interface 116 and perforated opening strip 136 are above the item-receiving chamber 120, and the hinge 112 is below the item-receiving chamber 120 along the bottom of the packaging unit 100. Alternative embodiments include packaging units in which this orientation is reversed such that the sealable interface and perforated opening strip are below the item-receiving chamber, and the hinge is above the item-receiving chamber along the top of the packaging unit. Further embodiments include packaging units in which the sealable interface and perforated opening strip are along a side portion of the packaging unit, and the hinge is along an opposite side portion of the packaging unit. Still further embodiments include packaging that do not include a hinge, but instead include some other means of joining the forward and rearward walls or panels of the packaging to each other.

As shown in FIGS. 3 and 4, the packaging unit 100 is generally trapezoidal or rectangular in plan view. Alternative embodiments may include differently configured (e.g., shaped, sized, etc.) packaging units.

FIG. 6 illustrates a pull tab or gripping corner 148 associated with the perforated opening strip 136. The pull tab 148 may be configured to facilitate a user in applying a manual force (e.g., gripping and pulling on, etc.) for removing the perforated opening strip 136 from the packaging unit 100. In this illustrated example, the pull tab 148 is integrally defined in the rearward wall 104 generally by perforations 128, 132 adjacent the free edge (e.g., left side edge in FIG. 3), such that the pull tab 148 is connected or disposed at an end portion of the perforated opening strip 136.

In this particular example, the pull tab 148 is generally triangularly shaped. Alternatively, the pull tab 148 may be configured differently (e.g., differently shaped, sized, etc.) and/or the pull tab 148 may be provided as a separate component that is attached (and not integral) to the perforated opening strip 136.

As shown in FIGS. 6 and 9, the forward wall 108 includes a notch or opening 156 through which a user may access the forward portion of the pull tab 148. For example, the notch or opening 156 allows a user to squeeze or pinch the pull tab 148 between the user's fingers.

An opening, hole, indentation, or recessed portion 152 may be provided in the pull tab 148 for receiving a user's fingernail to facilitate the user's application of a manual force (e.g., pulling on, etc.) for removing the perforated opening strip 136 from the packaging unit 100. As another example, the pull tab 148 may include a roughened or dimpled surface to facilitate a user in gripping and pulling on the pull tab 148.

In some embodiments, the pull tab 148 may be provided with indicia for instructing the user about removing the perforated opening strip 136 for opening the packaging unit 100. By way of example, the pull tab 148 may include written instructions, such as “PULL” or “OPEN”. Or, for example, the pull tab 148 may include an arrow or other visual cue to suggest a direction to pull on the pull tab 148. Alternative embodiments may omit the indicia on the pull tab, given that a user might intuitively understand how to remove the perforated opening strip 136 from the packaging unit 100.

The packaging unit 100 may also include an opening or hole 160, such as for hanging the packaging unit 100 from a hook of a merchandise display rack. Alternative embodiments may include packaging units without such an opening or hole.

A wide variety of materials and manufacturing processes may be used to make the packaging unit 100. By way of example, the packaging unit 100 may comprise plastic, such as 0.015 Polyethylene terephthalate (PETE), etc. By way of further example, the packaging unit 100 may be made by thermoforming the rearward and forward walls 104, 108 and die cutting (e.g., using a rotary die cutter having a blade length of about 3/16 inches and blades spaced apart about 1/32 inches, etc.) the perforations 128, 132 into the rearward wall 104 while the packaging unit 100 is flat and opened (FIG. 9). Alternative methods may be used for forming the packaging unit's walls (e.g., vacuum forming, drawing, etc.) and/or for forming the perforations (e.g., thermal forming, heat-weakening, scoring, heat-scoring, etc.). The perforations 128, 132 may be formed subsequent to the formation of the walls 104, 108, such as in the blanks for the walls 104, 108 before the walls are sealed or connected (e.g., heat-welded, etc.) to each other along or at the interface 116. Alternatively, the perforations 128, 132 may be formed prior to the formation of the walls 104, 108.

In one particular embodiment, the packaging unit 100 is thermoformed from a single piece of plastic (FIG. 9) such that the packaging unit 100 has a monolithic construction in which the hinge 112 is an integrally formed living hinge that connects the rearward and forward walls 104, 108. Alternative embodiments include packaging units having forward and rearwards walls that are separate, discrete pieces (e.g., pieces that are not hingedly or integrally connected to each other, etc.) and/or that joined or coupled to each other by some other means besides a hinge.

Dimensionally, the packaging unit 100 may be variously sized, depending, at least in part, on the particular item to be packaged therein. In one example, the packaging unit 100 may be dimensionally sized to have a width (W in FIG. 9) of about 5.125 inches, a length (L in FIG. 9) of about 17.6 inches, and a thickness (T in FIG. 9) of about 1.855 inches. Alternative embodiments may include a packaging unit sized differently.

Other aspects of the present disclosure relate to methods of making a packaging unit (e.g., 100, etc.) having first and second walls (e.g., 104, 108, etc.) that cooperatively define an item-receiving compartment (e.g., 120, etc.) therebetween and a perforated opening strip (e.g., 136, etc.) for opening the packaging unit after being sealed. As an example, one such method generally includes forming (e.g., die cutting, etc.) first and second sets of perforations (e.g., 128, 132, etc.) in a first wall of a packaging unit. The perforations penetrate at least partially through the first wall without penetrating a second wall of the packaging unit, such that a removable perforated opening strip is integrally defined in the first wall by the first and second sets of spaced-apart perforations generally between first and second portions of the first wall. Removal of the perforated opening strip only removes the portion of the first wall between the first and second sets of perforations without removing any portion of the second wall. The perforated opening strip may be removable from the packaging unit by application of a manual force (e.g., by a user gripping and puling to tear away the perforated opening strip without cutting, etc.) even while the first portion of the first wall is sealed to a first portion of the second wall. The removal of the perforated opening strip from the packaging unit may detach the first and second portions of the first wall from each other. This detachment, in turn, may then allow the second portion of the first wall to be movable relative to the second wall, and the first portion of the first wall sealed thereto, from a closed position towards an open position for opening the packaging unit.

After forming the perforations, the method may also include sealing (e.g., heat-sealing, etc.) the first portion of the first wall to the first portion of the second wall. An item may be positioned within the item-receiving compartment before sealing.

The perforations may be formed by die cutting the first wall. The die cutting process may include using a rotary die cutting having a blade length of about 3/16 inches and blades spaced apart about 1/32 inches. The perforations may be formed in the first wall while the packaging unit is in an open, flat configuration (e.g., FIG. 9, etc.).

The method may also include forming (e.g., thermoforming, etc.) the first and second walls such that a hinge connects the first wall to the second wall. After forming the walls (e.g., by thermoforming, etc.) and forming perforations of the packaging unit, the packaging unit may be provided to another party (e.g., another company or business entity, etc.) before sealing the packaging unit. This would allow the other party to position an item in the item-receiving compartment and/or to seal the packaging unit (e.g., at or along the sealable interface 116 or elsewhere etc.). After sealing the packaging unit, the perforated opening strip may thus provide for convenient opening of the sealed packaging unit that is tamper evident. The method may also include forming a pull tab (e.g., 148, etc.) that is configured to facilitate a user in applying a manual force (e.g., gripping and pulling, etc.) for removing the perforated opening strip from the packaging unit.

Further exemplary methods relate to packaging an item within a packaging unit (e.g. 100, etc.) having first and second walls (e.g., 104, 108, etc.) cooperatively defining an item-receiving compartment (e.g., 120, etc.) and a perforated opening strip (e.g., 136, etc.) integrally defined in the first wall by first and second sets of spaced-apart perforations (e.g., 128, 132, etc.) in the first wall. As an example, one such method generally includes sealing portions (e.g., interface 116, etc.) of the first and second walls of the packaging unit to each other while the item is within the item-receiving compartment, such that the perforated opening strip is generally between the item-receiving compartment and the sealed portions of the first and second walls. The method may also include positioning the item within the item-receiving compartment before sealing the portions (e.g., interface 116, etc.) of the first and second walls of the packaging unit. As another example, a method generally includes positioning an item within the item-receiving compartment of the packaging unit. In this latter example, the method may also include sealing portions of the first and second walls to each other after positioning the item, such that the perforated opening strip is generally between the item-receiving compartment and the sealed portions of the first and second walls.

Additional methods relate to opening a sealed packaging unit (e.g., 100, etc.) having first and second walls (e.g., 104, 108) cooperatively defining an item-receiving compartment (e.g., 120, etc.) and a perforated opening strip (e.g., 136, etc.) integrally defined in the first wall by first and second sets of spaced-apart perforations (e.g., 128, 132, etc.) in the first wall such that the perforated opening strip is generally between the item-receiving compartment and portions (e.g., 116, etc.) of the first and second walls that are sealed to each other. As an example, one such method generally includes removing the perforated opening strip from the packaging unit.

The method may also include, after removing the perforated opening strip from the packaging unit, moving the second wall relative to the first wall to open the packaging unit. The first and second walls may be connected by a hinge (e.g., 112). In which case, moving the second wall relative to the first wall may include hingedly moving the second wall relative to the first wall about the hinge to open the packaging unit.

The user may remove the perforated opening strip without breaking the seal between the first and second walls. The perforated opening strip may be removed while the portions of the first and second walls remain sealed to each other. The perforated opening strip may be formed entirely by a portion of the first wall such that removing the perforated opening strip only removes the portion of the first wall between the first and second sets of perforations without removing any portion of the second wall. Accordingly, the user may remove, detach, or tear away the perforated opening strip such that the seal, seam, joint, bond, connection, etc. between the portions (e.g., 116, etc.) of the first and second walls remains intact.

To remove the perforated opening strip, a user may pull on a pull tab at an end portion of the perforated opening strip. Plus, the user may remove the perforated opening strip without cutting the packaging unit.

Numerical dimensions, values, and specific materials disclosed herein are provided only for illustrative purposes in regard to certain embodiments, as other embodiments may be sized differently and/or made from other suitable materials. Accordingly, the particular dimensions, values, and specific materials provided herein are not intended to limit the scope of the present disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A packaging unit comprising:
a first wall including first and second portions and first and second sets of spaced-apart perforations;
a second wall including a first portion sealable to the first portion of the wall, and a second portion configured to cooperate with the second portion of the first wall to define an item-receiving compartment therebetween when the packaging unit is closed;
the first and second sets of spaced-apart perforations penetrate at least partially through the first wall such that a perforated opening strip is integrally defined in the first wall by the first and second sets of spaced-apart perforations generally between the first and second portions of the first wall;
whereby the perforated opening strip is removable such that the first portion of the first wall may remain sealed to the first portion of the second wall; and
whereby removal of the perforated opening strip detaches the first and second portions of the first wall from each other, thereby allowing the second portion of the first wall to be movable relative to the second wall from a closed position towards an open position for opening the packaging unit.

2. The packaging unit of claim 1, wherein the second portion of the first wall is hingedly connected to the second portion of the second wall, such that the second portion of the first wall is hingedly movable relative to the second portion of the second wall from a closed position towards an open position for opening the packaging unit after removal of the perforated opening strip.

3. The packaging unit of claim 1, wherein the packaging unit has a monolithic construction with an integrally formed living hinge connecting the second portion of the first wall to the second portion of the second wall.

4. The packaging unit of claim 3, wherein the living hinge is configured such that the second portion of the first wall is hingedly movable relative to the second portion of the second wall from a closed position towards an open position for opening the packaging unit after removal of the perforated opening strip even while the first portion of the first wall remains sealed to the first portion of the second wall.

5. The packaging unit of claim 3, wherein the first and second walls and the living hinge are monolithically formed from plastic.

6. The packaging unit of claim 1, further comprising a pull tab at an end portion of the perforated opening strip.

7. The packaging unit of claim 6, wherein the pull tab is integrally defined in the first wall generally by the first and second sets of spaced-apart perforations.

8. The packaging unit of claim 1, wherein the perforated opening strip is configured to be removable without having to cut the packaging unit even while the first portion of the first wall may remain sealed to the first portion of the second wall.

9. The packaging unit of claim 1, wherein:
the first and second walls respectively comprise rearward and forward walls of the packaging unit;
the perforated opening strip is defined so as to extend laterally across a width of an upper portion of the rearward wall; and
a hinge connects lower portions of the rearward and forward walls to each other.

10. The packaging unit of claim 1, wherein the first and second walls are unsealed to each other at least along a region generally between the perforated opening strip and the item-receiving compartment.

11. The packaging unit of claim 1, wherein:
the first wall is not sealed to the second wall; and/or
the first and second walls comprise thermoformed plastic.

12. The packaging unit of claim 1, wherein the perforations penetrate completely through the first wall without penetrating the second wall.

13. A packaging unit comprising:
a rearward wall;
a forward wall;
a hinge connecting the forward wall to the rearward wall;
a sealable interface associated with the rearward and forward walls generally opposite the hinge;
the rearward and forward walls cooperatively defining an item-receiving compartment generally between the hinge and sealable interface;
first and second sets of spaced-apart perforations that penetrate at least partially through the rearward wall such that a perforated opening strip is integrally defined in the rearward wall by the first and second sets of spaced-apart perforations generally between the sealable interface and the item-receiving compartment;
whereby removal of the perforated opening strip only removes the portion of the rearward wall between the first and second sets of perforations without removing any portion of the forward wall.

14. The packaging unit of claim 13, wherein:
the perforated opening strip is removable such that the forward wall may remain sealed to rearward wall along the sealable interface; and
the removal of the perforated opening strip detaches a first portion of the rearward wall associated with the sealable interface from a second portion of the rearward wall connected to the hinge, thereby allowing the forward wall, and the first portion of the rearward wall when sealed thereto, to be hingedly movable relative to the second portion of the rearward wall about the hinge from a closed position towards an open position for opening the packaging unit.

15. The packaging unit of claim 13, wherein:
the packaging unit has a monolithic construction; and/or
the hinge comprises an integrally formed living hinge; and/or
the packaging unit comprises thermoformed plastic; and/or
the forward wall is not sealed to the rearward wall.

16. The packaging unit of claim 13, further comprising a pull tab at an end portion of the perforated opening strip and integrally defined in the first wall generally by the first and second sets of spaced-apart perforations.

17. The packaging unit of claim 13, wherein the perforated opening strip is configured to be removable without having to cut the packaging unit even while the forward wall may remain sealed to the rearward wall along the sealable interface.

18. The packaging unit of claim 13, wherein:
the perforated opening strip is defined so as to extend laterally across a width of an upper portion of the rearward wall; and
the hinge connects lower portions of the rearward and forward walls to each other.

19. The packaging unit of claim 13, wherein:
the forward and rearward walls are unsealed to each other at least along a region generally between the perforated opening strip and the item-receiving compartment; and/or
the perforations penetrate completely through the rearward wall without penetrating the forward wall; and/or
the forward and rearward walls are sealed to each other at the sealable interface and remain sealed to each other at the sealable interface even after removal of the perforated opening strip.

20. The packaging unit of claim 13, wherein the forward and rearward walls are sealed to each other at the sealable interface with an item in the item-receiving compartment, whereby the perforated opening strip provides for a convenient opening of the packaging unit that is tamper evident.

21. A method of making a packaging unit, the method comprising:
forming first and second walls of the packaging unit that are connected by a hinge; and
forming first and second sets of perforations in the first wall that penetrate at least partially through the first wall without penetrating a second wall of the packaging unit, such that a removable perforated opening strip is integrally defined in the first wall by the first and second sets of spaced-apart perforations, whereby removal of the perforated opening strip only removes the portion of the first wall between the first and second sets of perforations without removing any portion of the second wall.

22. The method of claim 21, wherein:
forming the first and second walls includes thermoforming plastic such that an item-receiving compartment is defined between the first and second walls when the packaging unit is closed; and/or
forming the first and second sets of perforations in the first wall includes die cutting the first wall.

23. The method of claim 21, further comprising sealing a portion of the first wall to a portion of the second wall with an item in an item-receiving compartment of the closed packaging unit, whereby the perforated opening strip provides for convenient opening of the closed packaging unit that is tamper evident.

24. A method of packaging an item within a packaging unit having first and second walls cooperatively defining an item-receiving compartment and a perforated opening strip integrally defined in the first wall by first and second sets of spaced-apart perforations in the first wall, the method comprising sealing portions of the first and second walls of the packaging unit to each other with the item within the item-receiving compartment, such that the perforated opening strip is generally between the item-receiving compartment and the sealed portions of the first and second walls.
